(19) United States
(12) Patent Application Publication
(10) Pub. No.: US 2017/0050394 A1
(43) Pub. Date: Feb. 23, 2017

(54) Method For Manufacturing Of A Component

(71) Applicant: Airbus Operations GmbH, Hamburg (DE)

(72) Inventors: Axel Siegfried Herrmann, Stade (DE); Georg Lonsdorfer, Stade (DE); Hauke Seegel, Stade-Bützfleth (DE); Marc Fette, Hamburg (DE); Jens Wulfsberg, Hamburg (DE); Patrick Schiebel, Bremen (DE)

(73) Assignee: Airbus Operations GmbH, Hamburg (DE)

(21) Appl. No.: 15/234,192

(22) Filed: Aug. 11, 2016

(30) Foreign Application Priority Data
Aug. 18, 2015 (DE) 10 2015 113 688.0

(51) Int. Cl. B29C 70/46; B29C 65/48; B29C 35/08; B29C 65/00; B29C 70/18; B29C 70/54; B29C 65/56; B29C 65/52

(52) U.S. Cl. CPC B29C 70/46; B29C 65/562; B29C 65/4835; B29C 65/522; B29C 66/45; B29C 70/18; B29C 70/541; B29C 66/712; B29C 66/7212; B29C 66/72141; B29C 66/72143; B29C 35/0805; B29K 2309/08

(57) ABSTRACT

A method for manufacturing a component includes a) providing a first, plate-shaped semi-finished product and a second semi-finished product, the first semi-finished product including a first thermosetting reactive resin with non-directionally inserted long-stranded fibers, the second semi-finished product including an oriented network of endless fibers, the endless fibers having a mean length l of at least 80 mm, and the long-stranded fibers having a mean length k which is at least 30 mm shorter than that of the endless fibers; b) placing the second semi-finished product on top of the first semi-finished product so as to form a semi-finished product group; c) inserting the semi-finished group into a first molding part of a multi-part mold of a press, the semi-finished group covering between 70% and 95% of the first molding part after the insertion; d) extrusion forming of the semi-finished product group by the mold resulting in the component; and e) removing the component.

### FIELD OF THE INVENTION

The invention relates to a method for manufacturing a component by extrusion forming.

### BACKGROUND OF THE INVENTION

Fiber-plastic-composite components are known from the prior art. A fiber-plastic-composite component may also be referred to as a fiber reinforced plastic component. Doughy molding material made of a thermosetting reactive resin and glass fibers may be provided for manufacturing of fiber reinforced plastic components. The thermosetting reactive resin may also be referred to as matrix or matrix material. The glass fibers are mixed into the reactive resin in a randomly distributed manner. The doughy molding material may be provided ready for processing. In this case, it is a semi-finished product. Polyester resins or vinyl-ester resins may be used as reactive resin, for example. By means of a cutting mechanism, the glass fibers may be scattered onto the reactive resin as even as possible. Typical lengths of the glass fibers are between 25 mm and 50 mm.

Due to the limited length of the glass fibers, a thermosetting reactive resin with mixed glass fibers may also be used for complex components, in particular with small radii of curvature. This is because the thermosetting reactive resin may be formed, cut, unrolled, stretched and/or compressed particularly simple as long as it is not a completely polymerized semi-finished product. The limited length of the glass fibers does not prevent that the processing steps mentioned above can be carried out without greater effort.

As soon as the desired shape of the component to be manufactured is achieved, the reactive resin may be polymerized by heating so that solidification occurs and the component is formed.

One drawback of the method for manufacturing a component described above is characterized in that the component may have a low stiffness and/or a low strength.

Moreover, from the prior art, there are known so-called preimpregnated fibers which may also be referred to as prepreg. For example, prepregs may be textile semi-finished products preimpregnated with reactive resin, which semi-finished products may be cured at a specific temperature and/or at a specific pressure for manufacturing of components. The reactive resins used for impregnation may be thermosetting reactive resins which are not yet polymerized or not yet completely polymerized prior to curing. The textile semi-finished product preferably comprises endless fibers which are considerably longer than the glass fibers mentioned before.

Due to the long fiber length of the textile semi-finished product of the prepreg this is mostly not suitable as to follow especially small radii of curvature, for example as a result of bend-forming. However, the components made of a prepreg may have a high stiffness and/or a high strength.

The document “Combination of carbon fiber sheet molding Compound (SMC) and Prepreg compression molding in aerospace industry”, Procedia Engineering, Volume 81, 2014, pages 1601-1607, relates to a composite material which is made of a carbon fiber-SMC and a prepreg.

During attempts to manufacture such a composite material, it was found that the SMC and the prepreg have significantly different flow characteristics. In case the composite material is made by utilizing an extrusion forming process, this may result in an undesired distribution of the reactive resin with the inserted reinforcement fibers of the SMCs in relation to the prepreg, or vice versa.

### BRIEF SUMMARY OF THE INVENTION

There may be a need to provide a method for manufacturing a component of different semi-finished plastic products that comprises a preferably desired distribution of the shares of the semi-finished products of the component.

A method for manufacturing a component is proposed, wherein the method comprises the following steps:
a) Providing a first, plate-shaped semi-finished product and a second semi-finished product, wherein the first semi-finished product comprises a first thermosetting reactive resin with non-directionally inserted long-stranded fibers, wherein the second semi-finished product comprises an oriented network of endless fibers, wherein the endless fibers have a mean length of at least 80 mm, and wherein the long-stranded fibers have a mean length which is at least 30 mm shorter than the mean length of the endless fibers;
b) Placing the second semi-finished product on top of the first semi-finished product so that at least the first semi-finished product and the second semi-finished product form a semi-finished product group;
c) Inserting the semi-finished product group into a first molding part of a multi-part mold of a press, wherein the semi-finished product group covers between 70% and 95% of the first molding part after the insertion;
d) Extrusion forming of the semi-finished product group by means of the mold resulting in the component; and
e) Removing the component.

As can be derived from step a, the first semi-finished product is plate-shaped. Hence, the first semi-finished product may be designed as a foil, for example. Compared to a longitudinal extension or a lateral extension of the plate-shaped semi-finished product, which longitudinal extension or lateral extension may define a surface of the plate-shaped semi-finished product, a plate thickness of the semi-finished product, i.e., an extension of the semi-finished product in a direction orthogonal to the surface of the semi-finished product, may be particularly small. Hence, the plate thickness is maximally 1/10 of the lateral extension and/or of the longitudinal extension of the first semi-finished product, for example. Preferably, the first, plate-shaped semi-finished product shall be understood as being a first semi-finished product.

For example, the first, thermosetting reactive resin may be or may be based on an epoxy resin, a vinyl-ester resin and/or an unsaturated polyester resin. Preferably, the first, thermosetting reactive resin may be understood as being a first reactive resin.

Long-stranded fibers are inserted in an undirected manner into the first reactive resin for the first semi-finished product. For example, the long-stranded fibers may be distributed within the first reactive resin resulting in a random or arbitrary direction of the respective fibers. The long-stranded fibers may be, for example, carbon fibers, aramid fibers, natural fibers, and/or glass fibers. The long-stranded fibers may be shaped as a fiber fleece and/or a fiber mat. For this purpose, the long-stranded fibers may be designed as recycled long-stranded fibers. The recycled long-stranded fibers may be, for example, pyrolized and/or dry. The long-stranded fibers may have a mean length of the long-stranded fibers of 10 mm up to 79 mm, for example.

Preferably, the first semi-finished product may be designed as a so-called sheet molding compound (SMC), wherein the sheet molding compound comprises the first, thermosetting reactive resin with long-stranded fibers inserted in an undirected manner.

The first semi-finished product may be prefabricated prior to the provision according to step a). Hence, the first semi-finished product may be fabricated as a plate-shaped, doughy molding material.

Moreover, a second semi-finished product is provided according to step a). The second semi-finished product comprises a directed network of endless fibers. Endless fibers are characterized in that they have a mean length of the endless fibers of at least 80 mm. The directed network of endless fibers may be characterized in that the endless fibers are at least in part connected with each other and/or arranged such with respect to each other that the endless fibers support each other. The network of endless fibers may be created due to said connection or due to supporting each other. Moreover, the endless fibers may be laid and/or oriented at least substantially along a predetermined trajectory, so that the network of endless fibers is directed. The manufacturing of the second semi-finished product with the directed network of endless fibers may take place prior to the provision according to step a).

For example, the endless fibers may be designed as carbon fibers, aramid fibers, natural fibers, and/or glass fibers. The endless fibers may be arranged with respect to each other and/or connected with each other after their manufacturing, so that the network of endless fibers is created. This network of endless fibers forms a part of the second semi-finished product. Moreover, the second semi-finished product may comprise a second reactive resin. Preferably, the second reactive resin is a thermosetting reactive resin. The endless fibers of the second semi-finished product may be impregnated with the second reactive resin. The impregnation of the endless fibers with the second reactive resin may be utilized for supporting the alignment of the network of endless fibers. Hence, the network of endless fibers may first be directed and thereupon be impregnated with the second reactive resin, so that the endless fibers are connected with each other by means of the second reactive resin which causes a stabilization of the directed network of endless fibers. For example, the second reactive resin may be or may be based on an epoxy resin, a vinyl-ester resin, and/or an unsaturated polyester resin.

For the step a), the first reactive resin and/or the second reactive resin may not and/or in part be polymerized. Moreover, the first reactive resin and the second reactive resin may be based on the same reactive resin, may be made of the same material, and/or may be made of materials, in particular different materials, which can be connected directly with each other in a firmly bonded manner.

According to step a) it is provided that the long-stranded fibers have a mean length of the long-stranded fibers which is at least 30 mm shorter than the mean length of the endless fibers. Preferably, the endless fibers or the long-stranded fibers, respectively, are defined in that a mean length of endless fibers is at least 50 mm, 60 mm, 70 mm, 80 mm, 90 mm, or 100 mm longer than the mean length of long-stranded fibers. The component to be manufactured may have an especially high stiffness and strength due to the fact that for the endless fibers a considerably greater mean length is provided than for the long-stranded fibers.

Preferably, the endless fibers may have a mean length of endless fibers which corresponds to 60% up to 120%, preferably 70% up to 100% of a diagonal length of the component to be manufactured. Hence, in a theoretic stretched view, the endless fibers may extend along considerably more than half of the diagonal length of the component to be manufactured. Hence, the endless fibers are advantageously suitable as to achieve an especially advantageous force distribution, strength, and/or stiffness of the component to be manufactured.

According to step b), the second semi-finished product is put onto the first semi-finished product as to form the semi-finished product group. Basically, there may be provided further first semi-finished products and/or further second semi-finished products which may be laid upon each other in a multi-layer arrangement as to form the semi-finished product group. Thereby, it is preferably provided that a first semi-finished product always has direct adjoining contact to one of the second semi-finished products. For better understanding, a semi-finished product group at which the second semi-finished product lies on top of the first semi-finished product shall be exemplarily elucidated in the following. Analogue considerations apply if multiple second semi-finished products and multiple first semi-finished products are provided for the semi-finished product group.

Especially preferred, the second semi-finished product is laid onto the first semi-finished product in a manner such that the second semi-finished product completely lies onto the first semi-finished product. In particular, the second semi-finished product does not protrude beyond lateral edges of the first semi-finished product. Rather, it may be provided that an edge region of the first semi-finished product is not covered by the second semi-finished product. Thus, the second semi-finished product may be laid onto a region of the surface of the first semi-finished product which region is radially inside with respect to said edge region of the first semi-finished product. Hence, the second semi-finished product may be laid onto the first semi-finished product preferably centric. Other alignments may be provided. This in particular applies if the first semi-finished product and/or the second semi-finished product have an asymmetric shape. Basically, strategies for alignment of fibers for a fiber reinforced component are known from the prior art. These may be applied here, likewise.

According to step c), the semi-finished product group is inserted in a first molding part of a multi-part mold of a press. Thereby, the semi-finished product group covers the first molding part between 70% and 95% after insertion. The press may be an extruding press. The press may comprise multiple molding parts, one of which is the first molding part. The first molding part may comprise a base area onto or above which the semi-finished product group is laid. Hence, the first molding part may be formed shell-like and/or concave, for example. In this case, the semi-finished product group may be laid into the interior space of the first molding part. Thereby, the semi-finished product group covers the interior surface of the molding part between 70% and 95%. Basically, the first molding part may also not be shell-like, but may comprise a contact surface which is vaulted outwardly, for example. In this case, the semi-finished product group may be laid upon the contact surface of the molding part, wherein the semi-finished product group covers the contact surface between 70% and 95%. Therefore, inserting the semi-finished product group into the first molding part may also be understood as placing the semi-finished product group onto the first molding part. For example, the first molding part of the press may be a so-called matrix. Thus, the first molding part may define the outer shape of at least a part of the component. A second component of the press may be a stamp. This stamp may be designed corresponding to the matrix of the press. The stamp can be driven with respect to the first molding part such that a cavity is formed between the first molding part and the stamp, which cavity forms a negative to the component to be manufactured. Hence, the molding parts of the press may be designed drivable with respect to each other, in particular translational and/or rotatory moveable, as to form a cavity for the component to be manufactured in one state. The press serves for extrusion forming of the semi-finished product group for the component. Hence, the molding parts of the press may also be referred to as pressing tools.

According to step d), extrusion forming of the semi-finished product group resulting in a component takes place by means of the mold of the press after the semi-finished product group is inserted into the first molding part. Extrusion forming is basically known from the prior art. The extrusion forming may take place under pressure effect and/or heat effect onto the semi-finished product group. For this purpose, the first molding part and/or the further molding parts of the press may be heated, in particular isothermally and/or evenly internally heated. For example, this may take place by means of an oil heating and/or by means of oil ducts in the molding parts. Alternatively or additionally, an electric heating for heating the molding parts may be provided. During extrusion forming there are only very short flow paths as a result of the semi-finished product group already covering the first molding part after insertion to 70% up to 95%. A flow path relates to the distance of a reactive resin, in particular of the first reactive resin, of the semi-finished product group covered during the extrusion forming. Thus, the first reactive resin may be pressed radially outwards to the edge of the mold during extrusion forming. The distance coming up and covered during this pressing would then be the flow path. The semi-finished product group comprises the first plate-shaped semi-finished product as well as the second semi-finished product with the endless fibers. As elucidated before, it is preferably provided that the endless fibers of the second semi-finished product are already aligned such that they ensure advantageous material properties for the component to be manufactured. Hence, it is desirable that the alignment is maintained after the extrusion forming, too. The high, but not complete coverage of the first molding part by the semi-finished product group ensures a minimization of the deformation during the extrusion forming. Moreover, a reduction of pores, air inclusions, surface cracks and/or surface bridges may be ensured. However, as the semi-finished product group does not completely cover the first molding part, at least a small flow process of the at least one reactive resin of the semi-finished product group arises during extrusion forming. This ensures a consolidation and/or remainder impregnation of the endless fibers and/or long-stranded fibers.

Finally, the component may be taken out of the mold according to step e). Now, the component has the advantageous stiffness properties and/or strength properties which may result from the endless fibers. Furthermore, the component may have a complex shape, in particular with small radii of curvature, as the semi-finished product group which is used for the extrusion forming also comprises the first plate-shaped semi-finished product with the thermosetting reactive resin and the undirected long-stranded fibers which are considerably shorter than the endless fibers. Thus, the first reactive resin may serve to ensure manufacturing of the complex shape of the component. The strength, in particular in the region of small curvatures, may be ensured by the long-stranded fibers. Force transmissions in such regions may be transmitted via the long-stranded fibers to the endless fibers so that an advantageous force distribution comes up.

For an advantageous embodiment, the provision according to step a) may comprise a sub-step a1): heating of the first semi-finished product and/or the second semi-finished product to a molding heat temperature. The molding heat temperature may be chosen such that a polymerization of the first reactive resin and/or the second reactive resin does not start and/or a curing of the first or second reactive resin is not yet finished before step d) takes place. The preheating according to sub-step a1) may contribute to a reduction of the time required for the method, that is a reduction of a cycle time of the method, and in particular of the extrusion forming. In other words, preheating of the first semi-finished product and/or the second semi-finished product may contribute to an acceleration of the time required for the extrusion forming according to step d). Thereby, execution of the method as a whole is accelerated. Preheating may take place in the sub-step a1) or in a step which is executed prior to step a) which is the provisioning. This step may also be part of the method.

For a further advantageous embodiment, the extrusion forming according to step d) may comprise the sub-step d1): heating of the semi-finished product group. In particular, heating up or warming up of the semi-finished product group may also be understood as heating the semi-finished product group. Preferably, the temperature, in particular of the mold and/or the semi-finished product group, is controlled during heating such that the first and/or the second reactive resin polymerizes.

For a further advantageous embodiment, the extrusion forming according to step d) may comprise the sub-step d2): compressing the semi-finished product group by means of the mold, that is in particular by means of the first molding part and at least one further molding part of the press. Shaping of the semi-finished product group occurs during compression so that the semi-finished product group takes the shape of the component. The component maintains the desired shape after polymerization of the first and/or second reactive resin.

The sub-steps d1) and d2) may take place at the same time, partially timely overlapping and/or time-delayed. In particular, sub-step d1) may start prior to sub-step d2), or vice versa. Hence, heating of the semi-finished product group may start, for example, prior to the semi-finished product group being shaped to the desired shape of the component by driving the molding parts to each other. In case the molding parts are moved with respect to each other such that their interior space takes a negative of the outer shape of the desired component, the heating may be controlled such that the polymerization of the first and/or second reactive resin occurs. The molding parts may be driven apart if the polymerization is completed so that the component can be removed according to step e).

An advantageous embodiment of the method is characterized in that the long-stranded fibers have a mass portion of the first semi-finished product between 20 m % and 70 m %, preferably between 30 m % and 50 m %. A minimum share of the long-stranded fibers in the first semi-finished product ensures that the component to be manufactured has a desired strength and/or stiffness, in particular in the region of complex shape designs of the component to be manufactured. Because right in the complex shape regions of the component it is preferably the cured first semi-finished product which shapes the component to be manufactured. By means of the long-stranded fibers, arising forces may be distributed particularly well, in particular to the endless fibers. A particularly high mass portion of the long-stranded fibers, for example between 50 m % and 70 m %, ensures a particularly high stiffness and/or strength in the region of the component where the polymerized or cured first semi-finished product forms the component.

Preferably, the first semi-finished product has a thickness, in particular a plate thickness, of up to 5 mm. This ensures that the first semi-finished product is particularly well shapeable prior to the polymerization, in particular as to adapt to the shaping by means of the molding parts of the mold.

A further advantageous embodiment of the method is characterized in that the endless fibers have a mass portion in the second semi-finished product of between 20 m % and 95 m %, particularly preferred between 50 m % and 70 m %. With the preferred minimum share of the endless fibers in the second semi-finished product it is ensured that the component to be manufactured has a particularly high stiffness and/or strength. The endless fibers may have a mean fiber length of at least 80 mm or more. Thus, transmitted forces may be distributed particularly well during a force transmission into the component. The higher the share of the endless fibers in the second semi-finished product is, the higher transmitted forces may be distributed in the component.

A further advantageous embodiment of the method is characterized in that the reactive resin of the first and/or second semi-finished product may comprise a flame-resistant additive. For example, the flame-resistant additive may comprise aluminum hydroxide and/or be made of the same. The flame-resistant additive may have a weight share in the first or second semi-finished product of 20 m % up to 65 m %. The flame-resistant additive may function as flame retardant. The higher the share of the flame-resistant additive in the respective semi-finished product is, the harder the semi-finished product inflames. Hence, the corresponding also applies to the component to be manufactured. In flammable regions or in regions with especially high fire protection requirements, the flame-resistant additive may be provided for at least one of the two semi-finished products as to ensure that the component to be manufactured has a desired fire protection retardation.

A further advantageous embodiment of the method is characterized in that the semi-finished product group is shaped during the extrusion forming according to step d) such that the originating component fills out an interior space of the mold. Preferably, during the extrusion forming the semi-finished product group flows to the edge regions of the cavity which is at least in part formed by the first molding part. The flow paths are especially short due to the high coverage by the semi-finished product group so that it comes to the advantages mentioned above. Preferably, possible cavities and/or non-impregnated regions of the long-stranded fibers of the first semi-finished product and/or of the endless fibers of the second semi-finished product are closed and/or consolidated with the first and/or the second reactive resin during the extrusion forming.

A further advantageous embodiment of the method is characterized by step c1): firmly bonded fixing of the second semi-finished product onto the first semi-finished product. Preferably, the step c1) is executed prior to, after, and/or with the step c). In particular, the step c1) may be a sub-step of the step c). Thus, the step c1), that is the firmly bonded fixing, may take place prior to the inserting according to step c), or vice versa.

For firmly bonded fixing of the second semi-finished product onto the first semi-finished product, an adhesive means, in particular a binder, may be provided. Preferably, the adhesive means is a thermoplastic adhesive means. The adhesive means may be put, in particular sprayed, onto the first and/or the second semi-finished product prior to the second semi-finished product being put onto the first semi-finished product. The firmly bonded fixing may take place by heating, in particular by subsequent heating as well as a subsequent cooling of the thermoplastic adhesive means.

A pre-positioning of the second semi-finished product, in particular of the related endless fibers, onto the first semi-finished product may be achieved by the preferred firmly bonded fixing of the second semi-finished product onto the first semi-finished product. Preferably, the firmly bonded fixing may occur after the first and the second semi-finished product are laid into a pre-mold, which preferably at least substantially corresponds to the first molding part. After inserting into the pre-mold, the thermoplastic adhesive means may be heated and subsequently cooled again so that a firmly bonded fixing, in particular an adhesion, between the first semi-finished product and the second semi-finished product, in particular the related endless fibers, is created. Subsequently, the thereby created semi-finished product group or at least a part thereof may be inserted into the first molding part. The insertion may occur with an especially low error rate due to the preferably similar shaping of the first molding part and the pre-mold.

The fixing of the second semi-finished product onto the first semi-finished product ensures that an arrangement of the second semi-finished product with respect to the first semi-finished product already takes place prior to the extrusion forming. This arrangement is substantially maintained during extrusion forming and/or results in a very similar allocation due to the high coverage of the semi-finished product group with respect to the first molding part. Thus, a synergy effect arises from the fixing of the second semi-finished product onto the first semi-finished product and the design of the semi-finished product group which covers between 70% and 95% of the first molding part when inserting the semi-finished product group.

The shaping of the semi-finished product group may preferably occur by pre-forming tools or tool insertions as to enable an end contour and/or an insertion state into the mold of the press. Especially preferred, a mapping as exact as possible should be achieved by means of the pre-forming tools and/or tool insertions.

A further advantageous embodiment of the method is characterized in that the semi-finished product group is pre-reshaped prior to insertion into the first molding part of the mold of the press. For example, is may thus be of advantage if the pre-reshaping of the semi-finished product group takes place prior to the extrusion forming according to step d), in particular at a high complexity and/or geometry of the component to be manufactured. During the pre-reshaping, a three-dimensional pre-product may result from the semi-finished product group which pre-product thereupon forms the semi-finished product group for the subsequently following method steps.

For the pre-reshaping, the first semi-finished product and/or the second semi-finished product and/or the semi-finished product group may be provided with a thermoplastic binding agent which is, for example, intrinsic or formed as powder, which binding agent is activated at the pre-reshaping, in particular at thermal pre-reshaping and which maintains the desired shape when cooling or afterwards. The pre-reshaping may be executed by means of templates and/or automated by means of a robot. This increases the accuracy and a reproducibility.

A preferred embodiment of the method is characterized in that the semi-finished product group is cut to desired external dimensions prior to insertion of the semi-finished product group into the first molding part. This cutting may happen by means of a template and/or a computer-aided cutting device.

Handling of the semi-finished product group and/or the component to be manufactured may be executed for each one of the steps of the method by means of a robot and/or by means of a computer-aided handling unit.

A further advantageous embodiment of the method is characterized by the step c2): mechanic fixing of the second semi-finished product with respect to the first molding part and/or the second semi-finished product. Preferably, the step c2) may be executed prior to, after, and/or with the step c1) and/or the step c).

Hence, the mechanic fixing of the second semi-finished product may take place additionally or alternatively to the firmly bonded fixing of the second semi-finished product onto the first semi-finished product. Thus, a pre-positioning of the second semi-finished product relative to the first semi-finished product may be further improved or achieved so that a predetermination of the arrangement of the fibers, that is of the long-stranded fibers and the endless fibers, is achievable in the component to be manufactured during extrusion forming due to the high coverage of the semi-finished product group with respect to the first molding part.

Preferably, the second semi-finished product, in particular the related endless fibers, may be mechanically fixed with respect to the first molding part. The corresponding may be provided for the first semi-finished product group, and in particular for the related long-stranded fibers. Hence, a pre-positioning of the second semi-finished product, and in particular of the related endless fibers, relative to the first semi-finished product group may take place by means of the first molding part. Here, the first molding part may be a first stationary reference point. This may apply to the first semi-finished product as well as to the second semi-finished product.

Alternatively or additionally, the second semi-finished product may be mechanically fixed with respect to the first semi-finished product. Here, the mechanic fixation of the second semi-finished product may take place at and/or on the first semi-finished product. Thus, it is possible that the second semi-finished product is mechanically fixed directly at and/or on the first semi-finished product. Therefore, the first and/or second semi-finished product may be designed accordingly.

An advantageous embodiment of the method is characterized in that a fabric sheet is assigned to the second semi-finished product, on which fabric sheet the endless fibers are affixed. The fabric sheet may be a part of the second semi-finished product due to the assignment. The fabric sheet may be designed for mechanic fixation of the second semi-finished product or the endless fibers at and/or on the first semi-finished product. For this purpose, the endless fibers may initially be affixed at the fabric sheet. Preferably, the fabric sheet may be designed as a seam base. In this case, the endless fibers may be sewn at the fabric sheet. Preferably, the fabric sheet may be a fiber fabric, in particular a glass fiber fabric or a carbon fiber fabric. It is also possible that the fabric sheet is designed as a non-woven material, a mat or a thermoplastic foil. The fabric sheet preferably has a grammage of less than 200 g/m². Therefore, the fabric sheet may have an especially low weight share in the second semi-finished product. Moreover, the fabric sheet may be designed such that it has an especially high friction coefficient such that the fabric sheet ensures an especially high friction between the fabric sheet and the first semi-finished product when laid onto the first semi-finished product. In other words, the fabric sheet may hold and/or mechanically fix the second semi-finished product on the first semi-finished product.

A further advantageous embodiment of the method is characterized in that the mechanic fixation in step c2) comprises a mounting, by a fixation means, of the second semi-finished product at the first molding part or at a component which is stationary with respect to the first molding part. Hence, the fixation means may serve for mounting of the second semi-finished product at the first molding part itself. Alternatively or additionally, the second semi-finished product may be fixed at the stationary component, that is stationary with respect to the first molding part, by means of the fixation means or an additional fixation means. The component which is stationary with respect to the first molding part may be, for example, a holder of the first molding part and/or a holder, in particular a clamping frame, of the press. A pre-positioning of the endless fibers of the second semi-finished product may be aimed to achieve by the attachment of the second semi-finished product. This serves for positioning of the endless fibers in the component to be manufactured. The component may be designed especially secure for absorption of high forces if the endless fibers in the component to be manufactured have the desired arrangement. Attachment of the second semi-finished product may, in particular, be understood as attachment of the endless fibers of the second semi-finished product. Hence, the attachment may be limited to the endless fibers of the second semi-finished product. This ensures that the endless fibers have the desired position in the component to be manufactured.

A further advantageous embodiment of the method is characterized in that the second semi-finished product is attached by means of needles as fixation means which needles are directed from the second semi-finished product to the first molding part or to the component which is stationary thereto. Preferably, when referring to needles, this is to be understood as rod-shaped elements. It was recognized as being advantageous if the needles are designed as metal needles. Then, they have an especially high melting point. Hence, they may substantially maintain their form stability during the extrusion forming. The needles may be designed as traction-needles for transmission of tensile forces. For example, a multitude of needles may be distributed over an edge region and directed from the second semi-finished product to the first molding part or to the component being arranged stationary thereto as to tighten the second semi-finished product by means of the needles. Thus, a pre-positioning may take place. The needles may have an especially small diameter. The diameter of the needles may, for example, be less than 1/10 of a mean layer thickness of the component to be manufactured. Thus, the needles may be removed after manufacturing of the component. Removing of the needles thereupon results in little weakening of the component due to their small diameter. On the other hand, removing of the needles may result in a better bending property of the component which may be of advantage for specific applications. Moreover, the component may then be designed free of metal. This is likewise of advantage for specific applications. Preferably, the needles may be affixed at the endless fibers of the second semi-finished product. Thereupon, the needles may serve for mechanic fixation of the endless fibers at the first molding part and/or at a component which is stationary with respect to the first molding part. This ensures that at least the endless fibers can be pre-positioned as to have the desired positioning in the component to be manufactured.

A further advantageous embodiment of the method is characterized in that the fabric sheet forms the fixation means. Hence, the fabric sheet may be formed for mechanic fixation of the second semi-finished product or the related endless fibers at the first molding part and/or a component being arranged stationary with respect to the first molding part. Thus, the second semi-finished product or the related endless fibers may be tightened, for example, at a clamping frame of the first molding part and/or a holder which also holds the molding part so that a pre-positioning of the second semi-finished product or the related endless fibers may happen. The fabric sheet can be handled especially easy and can be tightened by means of a clamping frame. This embodiment is therefore characterized by an easy and secure handling.

A further advantageous embodiment of the method is characterized by step c2.1): inserting an insertion part in the semi-finished product group, wherein the mechanic fixation according to step c2) comprises a fastening of the second semi-finished product to the insertion part. Preferably, the step c2.1) is executed prior to and/or with the step c2). The insertion part may be held and/or detachably fastened at the first molding part and/or at another molding part of the mold. Hence, the insertion part may be a reference point for the alignment of the semi-finished product group and/or the second semi-finished product so that the semi-finished product group or the second semi-finished product can be aligned very precisely relative to the mold of the press. For example, the insertion part is a metal insertion part. The insertion part may also be a so-called “thread insert”, a bushing, a bearing ring, an attachment bolt, a hook, a plate, and/or another part, in particular a metallic part. Preferably, the insertion part is formed especially rigid. Therefore, it may also serve for forming said reference point. Attachment of the second semi-finished product at the insertion part may happen by means of attachment of the endless fibers at the insertion part and/or attachment of a second reactive resin of the second semi-finished product at the insertion part. In particular, a weaving may be provided which fastens the endless fibers of the second semi-finished product at the insertion part. An insertion part may be a specific part of a component to be manufactured. Preferably, strong forces may be introduced into the component at the insertion part. Therefore, it is of advantage if the alignment of the endless fibers with respect to the insertion part is particularly precise. A particularly precise positioning of the endless fibers relative to the entire shape of the component to be manufactured and/or to the insertion part is ensured due to the preferred, particularly, detachable attachment or holding of the insertion part at a molding part of the mold of the press.

A further advantageous embodiment of the method is characterized by step c3): tightening of the second semi-finished product by means of a clamping device. Preferably, the step c3) is executed after and/or with the step c2), c2.1), c1) and/or c). When referring to tightening of the second semi-finished product, this may be particularly understood as tightening the endless fibers of the second semi-finished product. In particular, a drivable, that is, for example, a movable tightening device of the press may be provided as clamping device. The at least one fastening means may serve as a further clamping device, in particular. In other words, the at least one fastening means may be designed as clamping device. Particularly, the nails and/or the fabric sheet may be tightened as to achieve tightening of the second semi-finished product, in particular of the related endless fibers. This ensures a particularly precise pre-positioning of the endless fibers which ensures an especially accurate arrangement of the endless fibers in the component to be manufactured. Using of a clamping device and/or of the fastening means for tightening of the second semi-finished product, in particular of the related endless fibers, can be handled particularly easy. Thus, the desired positioning of the endless fibers may be achieved particularly easy and efficient.

An advantageous embodiment of the method is characterized in that the clamping device comprises clamping means for detachable clamping of the opposite ends of the fabric sheet, and wherein the clamping of the second semi-finished product happens by tightening the fabric sheet by means of the clamping means. For example, clamping strips may be provided as clamping means as to hold the fabric sheet tightened and/or fixed. The clamping means may be assigned to the mold, in particular to the first molding part. This enables a particularly compact design of the press.

A further advantageous embodiment of the method is characterized by the step c4): curing of the second semi-finished product by means of microwaves, wherein the second semi-finished product comprises nanoparticles. Preferably, the step c4) is executed prior to, after, and/or with the step c3), c2), c2.1), c1) or c). The second semi-finished product may comprise a second reactive resin with the nanoparticles. The endless fibers of the second semi-finished product may be impregnated with the second reactive resin. When referring to curing, this may be understood as increasing a viscosity of the second semi-finished product, in particular of the relates second reactive resin. Due to the fact that the second semi-finished product and in particular the related second reactive resin is exposed to microwaves, a stiffening of the second reactive resin of the second semi-finished product occurs so that the second semi-finished product or the related second reactive resin have a higher viscosity. Preferably, the second semi-finished product is in direct contact to the mold, in particular to the related first molding part and/or a pre-mold so that the mold or the pre-mold define a shaping of the second semi-finished product during the curing. If the curing is finished, the second semi-finished product may have the desired outer shape which is provided for the further steps of the method.

A further advantageous embodiment of the method is characterized in that the extrusion forming is done with the mechanically fixed, firmly bonded fixed and/or tightened second semi-finished product. The fixation or the tightening ensures a lowest possible moving of the second semi-finished product, in particular of the related endless fibers, during the extrusion forming. This enables a particularly accurate arrangement of the endless fibers in the component to be manufactured which provides a particularly high stiffness and/or strength, in particular at the lines of force to be expected.

A further advantageous embodiment is characterized in that a computer program product is provided for controlling a device for manufacturing a component, which computer program product executes the method according to one of the previously mentioned embodiments when being executed.

A further advantageous embodiment is characterized by a computer data medium which has stored a computer program product according to the previously mentioned embodiment.

### BRIEF DESCRIPTION OF THE DRAWINGS

Further features, advantages and application possibilities of the invention can be derived from the following description of exemplary embodiments and the drawings. Thereby, all described and/or visually depicted features for themselves and in any combination form an advantageous subject matter of the invention independent of their combination in the individual claims or their dependencies. Furthermore, in the drawings, same reference signs indicate same or similar objects.

FIG. 1 shows a first schematic flow chart of an embodiment of the method,

FIG. 2 shows a multitude of first semi-finished products 20 and a multitude of second semi-finished products 22 in a schematic perspective representation,

FIG. 3 shows an exemplary embodiment of an open mold with a semi-finished product group arranged therein in a schematic cross sectional view,

FIG. 4 shows a closed mold with a semi-finished product group received therein in a schematic cross sectional view,

FIG. 5 shows in a schematic cross sectional view the open mold with a component being manufactured in between,

FIG. 6 shows in a schematic cross sectional view the first semi-finished product along a section in vertical direction,

FIG. 7 shows in a schematic cross sectional view the first semi-finished product along a section in horizontal direction,

FIG. 8 shows in a schematic cross sectional view the second semi-finished product along a section in vertical direction,

FIG. 9 shows in a schematic cross sectional view the second semi-finished product along a section in horizontal direction,

FIG. 10 shows a schematic top view onto the semi-finished product group which is inserted into the first molding part,

FIG. 11 shows a second schematic flow chart of a further embodiment of the method,

FIG. 12 shows a third schematic flow chart of a further embodiment of the method,

FIG. 13 shows a fourth schematic flow chart of a further embodiment of the method,

FIG. 14 shows a fifth schematic flow chart of a further embodiment of the method, and

FIG. 15 shows a sixth schematic flow chart of a further embodiment of the method.

### DETAILED DESCRIPTION

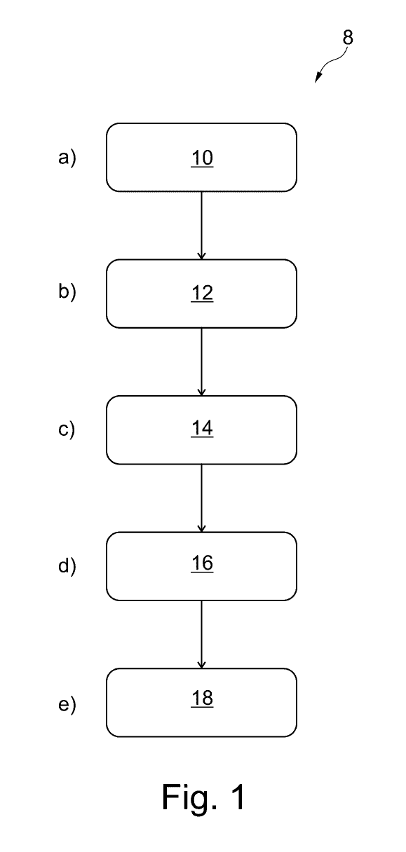

In FIG. 1, a schematic flow chart of a preferred embodiment of the inventive method 8 is shown. The method 8 comprises providing 10 in step a), placing 12 in step b), inserting 14 in step c), extrusion forming 16 in step d), and removing 18 in step e).

According to step a), providing 10 of a first plate-shaped semi-finished product 20 and a second semi-finished product 22 is provided. The first semi-finished product 20 comprises a first thermosetting reactive resin 24 with undirected inserted long-stranded fibers 26. The second semi-finished product 22 comprises a directed network 28 of endless fibers 30. The endless fibers 30 have a mean length of endless fibers 1 of at least 80 mm. The long-stranded fibers 26 have a mean length of long-stranded fibers k. The mean length of long-stranded fibers k is at least 30 mm shorter than the mean length of endless fibers 1.

According to step b), placing 12 of the second semi-finished product 22 onto the first semi-finished product 20 is provided so that at least the first semi-finished product 20 and the second semi-finished product 22 form a semi-finished product group 32.

According to step c), inserting 14 of the semi-finished product group 32 into a first molding part 34 of a multi-part mold 36 of a press 38 is provided, wherein the semi-finished product group 32 covers between 70% and 95% of the first molding part 34 after the insertion.

According to step d), extrusion forming 16 of the semi-finished product group 32 by means of the mold 36 resulting in the component 40 is provided.

According to step e), removing 18 of the component 40 is provided.

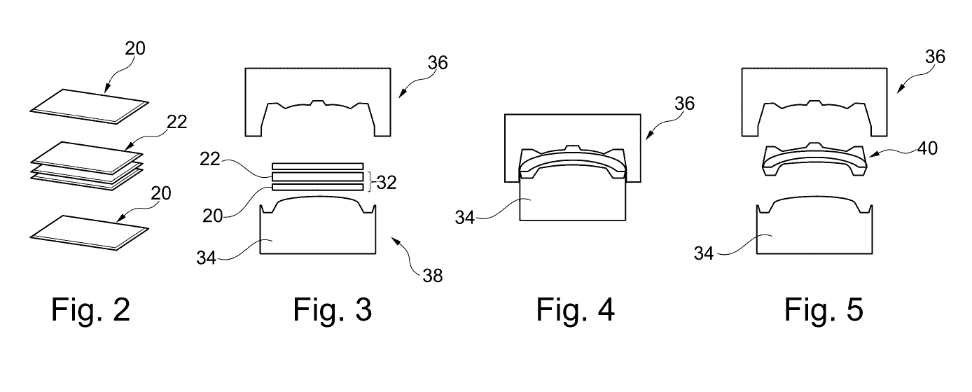

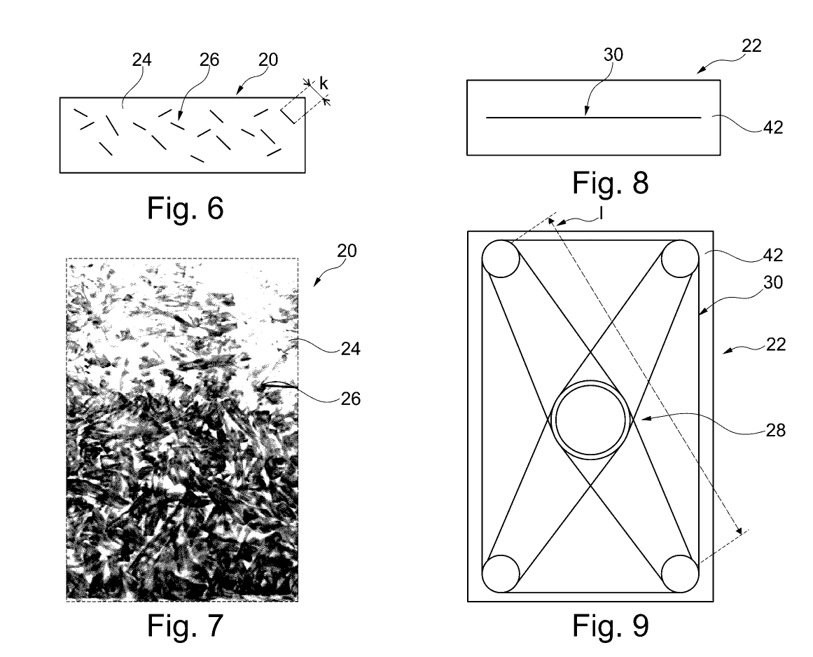

In FIG. 2 there are multiple first semi-finished products 20 and multiple second semi-finished products 22 shown, each of which are spaced apart from each other. FIG. 6 shows in a schematic cross sectional view of one of the first semi-finished products 20 along a vertical section. In FIG. 6 there can be recognized the undirected inserted long-stranded fibers 26. The long-stranded fibers 26 are inserted into the first thermosetting reactive resin 24.

In FIG. 7 there is depicted the previously mentioned first semi-finished product 20 in a further schematic cross sectional representation along a horizontal section through the first semi-finished product 20. The first thermosetting reactive resin 24 as well as the undirected long-stranded fibers 26 inserted into the first thermosetting reactive resin 24 can be recognized. The long-stranded fibers 26 have a length of long-stranded fibers of maximally 70 mm, for example. They may be inserted randomly distributed into the first thermosetting reactive resin 24. Within the first reactive resin 24, the long-stranded fibers 26 are not ordered. The long-stranded fibers 26 may be designed as carbon long-stranded fibers 26, for example.

In FIG. 8 the second semi-finished product 22 is shown in a schematic cross sectional view along a vertical section through the second semi-finished product 22. The second semi-finished product 22 comprises endless fibers 30. The endless fibers 30 may be inserted into a second reactive resin 42 of the second semi-finished product 22. Alternatively, the endless fibers 30 may be impregnated with the second reactive resin 42.

In FIG. 9 the second semi-finished product 22 is shown in a schematic cross sectional view along a horizontal section through the second semi-finished product 22. It can be recognized that the endless fibers 30 are formed aligned as network 28. Hence, they have a predetermined direction and/or common shape along the network 28. The network 28 of endless fibers 30 may be applied onto the second reactive resin 42. Alternatively, as shown in FIG. 8, the network 28 of endless fibers 30 may be inserted into the second reactive resin 42 of the second semi-finished product 22.

The endless fibers 30 have a mean length of endless fibers 1 of at least 80 mm. This preferably corresponds to at least 60%, 70%, 80%, 90% of a diagonal length of a component 40 to be manufactured.

As can be recognized in FIG. 3, at least one of the second semi-finished products 22 is laid onto at least one of the first semi-finished products 20 during placing 12 according to step b) so that the at least one first semi-finished product 20 and the at least one second semi-finished product 22 form a semi-finished product group 32. Additional first semi-finished products 20 and/or further second semi-finished products 22 may be laid upon the semi-finished product group 32. Hence, these may also form the semi-finished product group 32.

As also indicated in FIG. 3, the semi-finished product group 32 is inserted into a first molding part 34 of a multi-part mold 36 of a press 38 during step c), that is during insertion 14.

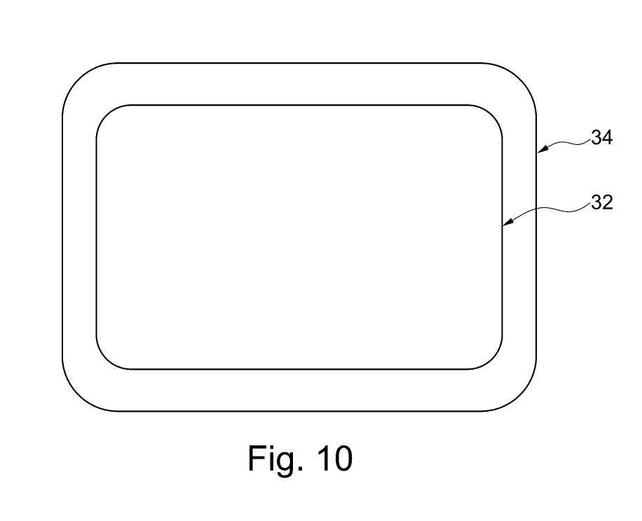

In FIG. 10, a schematic top view onto the semi-finished product group 32 and the first molding part 34 arranged underneath can be seen. The cross sectional area of the semi-finished product group 32 is smaller than a cross sectional area of an opening of the first molding part 34. Here, it is provided that after the insertion 14 the semi-finished product group 32 covers between 70% and 95% of the first molding part 34, namely preferably the opening of the first molding part 34. Thereby, the coverage preferably refers to the cross sectional areas of the semi-finished product group 32 or of the opening of the first molding part 34, respectively.

In FIG. 4, step d) is shown, that is the extrusion forming 16 of the semi-finished product group 32 by means of the mold 36 resulting in a component 40. Therefrom, it is evident that due to the high coverage of the first molding part 34 by the semi-finished product group 32 only a small flow path occurs, namely primarily relating to the first reactive resin 24 and/or the second reactive resin 42. This is because the semi-finished product group 32 almost completely projects up to an inner casing wall of the first molding part 34. The remaining flow path is suitable as to reduce pores and/or air inclusions. Moreover, a consolidation and/or rest impregnation of the endless fibers 30 and/or of the long-stranded fibers 26 happens due to the remaining flowing. Due to the high coverage, almost no moving of the network 28 of the endless fibers 30 happens. Rather, the alignment and/or design of the network 28 of endless fibers 30 is maintained as it is provided for the second semi-finished product 22.

If the component 40 is created by means of the extrusion forming 16, wherein preferably the first and/or the second reactive resin 24, 42 are polymerized or cured, the component may be removed according to step e). Removing of the component is schematically shown in FIG. 5.

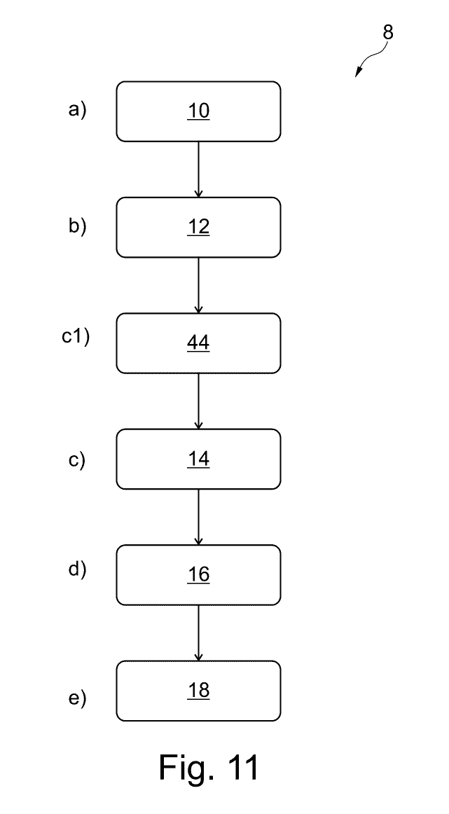

In FIG. 11, a schematic flow chart of a preferred embodiment of the method 8 is shown. In contrast to the flow chart shown in FIG. 1, the method as for now also comprises the step c1). According to step c1), a firmly bonded fixing 44 of the second semi-finished product 22 onto the first semi-finished product 20 is provided. The step c1) is executed prior to the step c), that is the insertion of the semi-finished product group 32 into the first molding part 34. According to step b), the second semi-finished product 22 is already laid onto the first semi-finished product 20 as to thereby form the semi-finished product group 32. According to step c1) which is subsequent to the step b), as for now also a firmly bonded fixing 44 happens. For this purpose, an adhesive means, in particular a binder, may be provided. This may preferably be a thermoplastic adhesive means which was previously applied or preferably sprayed onto the first semi-finished product 20 and/or the second semi-finished product 22. As to gain the firmly bonded fixation now, the thermoplastic adhesive means is heated and subsequently cooled. This results in a firmly bonded connection of the adhesive means with the thermosetting reactive resin 24 of the first semi-finished product 20 as well as with the endless fibers 30 of the second semi-finished product 22 and/or with the second reactive resin 42 of the second semi-finished product 22. Due to the firmly bonded fixation, a pre-positioning of the endless fibers 30 relative to the first semi-finished product 20 happens. Furthermore, due to this also a pre-positioning of the endless fibers 30 within the semi-finished product group 32 happens. This ensures that the component 40 to be manufactured has the endless fibers 30 or the network 28 of the endless fibers 30 at the desired position.

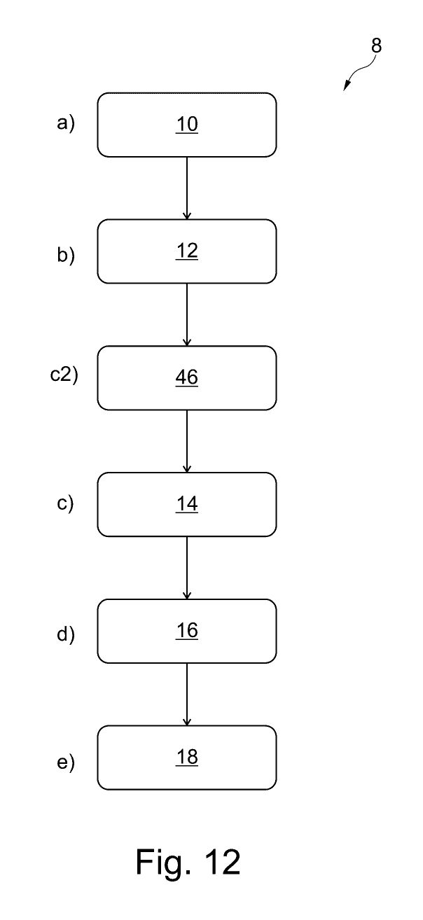

In FIG. 12, an additional schematic flow chart of a preferred embodiment of the method 8 is shown. Thereby, the method 8 comprises steps as being elucidated with reference to FIG. 1. Moreover, step c2) is provided for the method: mechanic fixation 46 of the second semi-finished product 22 with respect to the first molding part 34 and/or the first semi-finished product 20. The mechanic fixation 46 according to step c2) preferably happens prior to insertion 14 according to step c). Moreover, it is provided that the mechanic fixation 46 according to step c2) happens after the placing 12 according to step b). The second semi-finished product 22 may be fastened with respect to the first molding part 36 and/or to a component which is stationary with respect to the first molding part 36 for the purpose of the mechanic fixation 46. Preferably, a fixation means may be provided for this purpose. These are needles, for example. Alternatively or additionally, the second semi-finished product 22 may be mechanically fixed 46 with respect to the first semi-finished product 20. For example, this may be described by the mechanic fixation of the second semi-finished product 22 at and/or on the first semi-finished product 20. For example, the second semi-finished product 22 may be fastened on the first semi-finished product 20 for mechanic fixation. This may happen by means of a fixation means which is, for example, a fabric sheet of the second semi-finished product 22. The network 28 of the endless fibers 30 may be fasted at the fabric sheet which is designed as a seam base, for example, so that a placing of the fabric sheet onto the first semi-finished product 20 already ensures a pre-arrangement of the endless fibers 30 on the first semi-finished product 20. The fabric sheet may have a roughness which ensures a mechanic fixation with respect to the first semi-finished product 20. Further preferred, the fabric sheet may be sprayed and/or otherwise impregnated with a thermoplastic adhesive means. However, if the fabric sheet is now heated and finally cooled, a bonding effect between the fabric sheet and the first semi-finished product 20 is generated by the thermoplastic adhesive means. For example, the fabric sheet may be a glass fiber fabric, a non-woven fabric and/or a fiber mat.

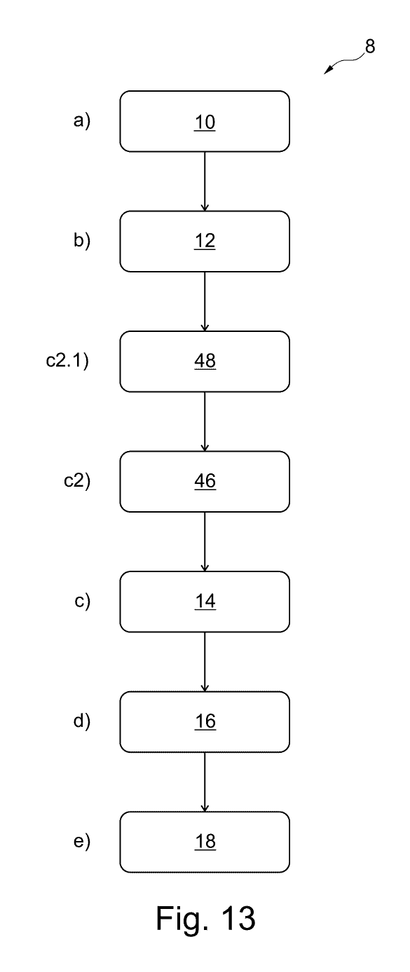

In FIG. 13, a flow chart of a further advantageous embodiment of the inventive method is schematically shown. The method corresponds to the previously elucidated method with reference to FIG. 12, however, with the exception that between the step b) and c2) a further step c2.1) is provided, namely the insertion 48 of an insertion part into the semi-finished product group 32, wherein the mechanic fixation 46 in step c2) comprises a fastening of the second semi-finished product 22 at the insertion part. The insertion part may be detachably fastened at the first molding part 34 of at another molding part of the mold 36. For example, the insertion part may be a thread insert, a bushing, a bearing ring or another metallic part. The insertion part serves as fixation basis when being inserted into the semi-finished product group 32. Therefore, the second semi-finished product 22 may be fastened and/or positioned at the insertion part. This ensures a very precise alignment of the endless fibers 30 with respect to the insertion part, wherein at the component 40 to be manufactured especially strong forces may be transmitted by the insertion part to the component 40. Thereupon, these forces may be distributed particularly well in the component 40 due to the purposeful arrangement of the endless fibers 30.

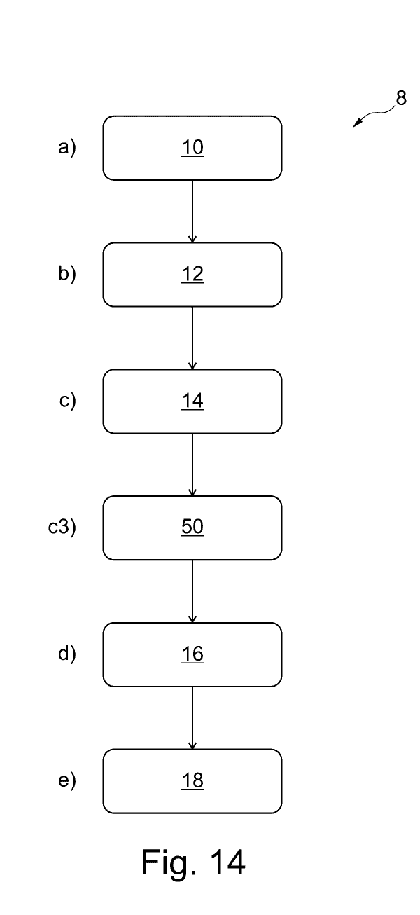

In FIG. 14, a schematic flow chart of a further advantageous embodiment of the method is shown, wherein the method steps correspond to those of the explanations given with reference to FIG. 1, however, with the exception that between the method step c) and the method step d) a further method step c3) is provided: clamping 50 of the second semi-finished product 22 by means of a clamping device. For example, nails may be used as clamping device as to tighten the endless fibers 30 of the second semi-finished product 22 so that the network 28 of the endless fibers 30 has a preferred alignment. Alternatively or additionally, a fabric sheet of the second semi-finished product 22 at which fabric sheet the endless fibers 30 are fastened may be clamped as the obtain a preferred alignment of the network 28 of the endless fibers 30. The extrusion forming 16 may thereupon happen with the clamped second semi-finished product 22.

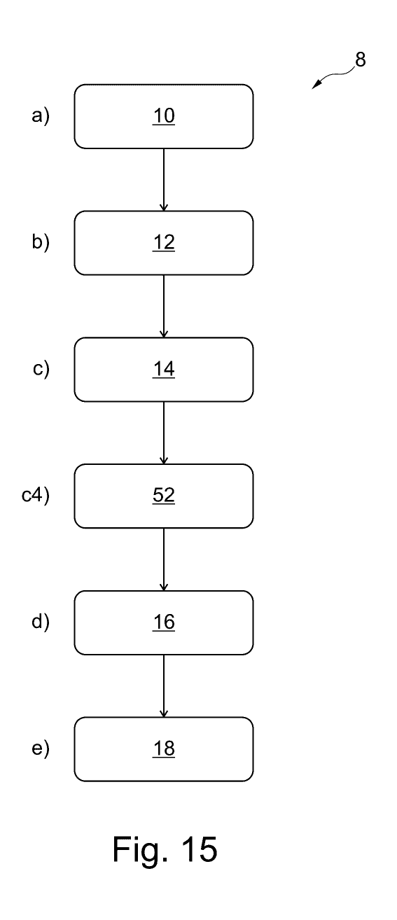

In FIG. 15, a schematic flow chart of a further advantageous embodiment of the method is shown, which comprises the steps which also have been previously explained with reference to FIG. 1, however, there is provided a further method step c4) between the method step c) and d): curing 52 of the second semi-finished product 22 by means of microwaves, wherein the second semi-finished product 22 comprises nanoparticles. Curing 52 may mean increasing a viscosity of the second semi-finished product 22, in particular of the related second reactive resin 42. Stiffening of the second reactive resin 42 may happen due to using of the microwaves so that the second semi-finished product 22 has the increased viscosity. During the curing 52, the second semi-finished product may be in direct or indirect contact with the first molding part 34 or a correspondingly designed pre-mold, so that the second semi-finished product 22 undergoes the curing 52 in a pre-shaped design. The contact of the second semi-finished product 22 to the pre-mold or the first molding part 34 may happen with the semi-finished product group 32 of which the second semi-finished product 22 forms apart.

Additionally, it is noted that “comprising” does not exclude any other elements and “a” or “an” does not exclude a plurality. It is further noted that features which are described with reference to one of the above exemplary embodiments may also be used in combination with other features of other exemplary embodiments described above. Reference signs in the claims are not to be construed as a limitation.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method for manufacturing a component, the method comprising:
a) Providing a first, plate-shaped semi-finished product and a second semi-finished product, wherein the first semi-finished product comprises a first thermosetting reactive resin with non-directionally inserted long-stranded fibers, the second semi-finished product comprises an oriented network of endless fibers, the endless fibers have a mean length l of at least 80 mm, and the long-stranded fibers have a mean length k which is at least 30 mm shorter than the mean length of the endless fibers;
b) Placing the second semi-finished product on top of the first semi-finished product so that at least the first semi-finished product and the second semi-finished product form a semi-finished product group;
c) Inserting the semi-finished product group into a first molding part of a multi-part mold of a press, wherein the semi-finished product group covers between 70% and 95% of the first molding part after the insertion;
d) Extrusion forming of the semi-finished product group by means of the mold resulting in the component; and
e) Removing the component.

2. The method according to claim 1, wherein the long-stranded fibers have a mass portion in the first semi-finished product of between 20 m % and 70 m %.

3. The method according to claim 1, wherein the endless fibers have a mass portion in the second semi-finished product of between 20 m % and 95 m %.

4. The method according to claim 1, wherein the semi-finished product group is shaped during the extrusion forming such that the originating component fills out an interior space of the mold.

5. The method according to claim 1, further comprising:
c1) firmly bonded fixing of the second semi-finished product on top of the first semi-finished product.

6. The method according to claim 1, further comprising:
c2) mechanic fixing of the second semi-finished product with respect to the first molding part and/or the first semi-finished product.

7. The method according to claim 6, wherein a fabric sheet is assigned to the second semi-finished product, on which fabric sheet the endless fibers are affixed.

8. The method according to claim 6, wherein the mechanic fixing comprises in step c2) a fastening, by a fixation means, of the second semi-finished product at the first molding part or at a component which is stationary with respect to the first molding part.

9. The method according to claim 8, wherein the second semi-finished product is fastened by needles as fixation means, the needles being directed from the second semi-finished product to the first molding part or to the component which is stationary thereto.

10. The method according to claim 8, wherein the fabric sheet forms the fixation means.

11. The method according to claim 7, further comprising:
c2.1) inserting an insertion part into the semi-finished product group, wherein the mechanic fixing in step c2) comprises a fastening of the second semi-finished product at the insertion part.

12. The method according to claim 1, further comprising:
c3) clamping of the second semi-finished product by a clamping device.

13. The method according to claim 12, wherein the clamping device comprises clamping means for detachable clamping of the opposite ends of the fabric sheet, and the clamping of the second semi-finished product happens by tightening the fabric sheet by the clamping means.

14. The method according to claim 1, further comprising:
c4) curing of the second semi-finished product by means of microwaves, wherein the second semi-finished product comprises nanoparticles.

15. The method according to claim 6, wherein the extrusion forming happens with the mechanically fixed and/or clamped second semi-finished product.
